(19) United States
(12) Patent Application Publication
(10) Pub. No.: US 2006/0139233 A1
(43) Pub. Date: Jun. 29, 2006

(54) Image display apparatus for displaying composite images

(76) Inventors: Adam Richard Neale, Brynben (GB); Ian Murdoch Macpherson, West Sussex (GB); Richard Robert Brown, East Sussex (GB)

Correspondence Address: Iandiorio & Teska, 260 Bear Hill Road, Waltham, MA, 02451, US

(21) Appl. No.: 10/562,187

(22) PCT Filed: May 19, 2004
(86) PCT No.: PCT/GB04/02147

§ 371 Date: Dec. 22, 2005

(30) Foreign Application Priority Data
Jun. 27, 2003 (GB) 0315116.4

(51) Int. Cl. G09G 5/00

(52) U.S. Cl. 345/1.1

(57) ABSTRACT

Image display apparatus (2) for displaying composite images, which image display apparatus (2) comprises a primary image source (4), at least one secondary image source (6), first distortion, means (12) for distorting the image geometry of the secondary image source (6) such that the image geometry of the secondary image source (6) matches that of the primary image source (4), combining means (18) for combining images from the primary image source (4) with the distorted images from the secondary image source (6), second distortion means (20) for distorting the composite images, and display means (22) for displaying the composite images.

This invention relates to image display apparatus and, more especially, this invention relates to image display apparatus for displaying composite images. The image display apparatus is for displaying composite images from more than one image source. The composite images appear geometrically correct to an observer when displayed on a display surface.

Image display apparatus is well known that is able to display overlapping or composite images. Computer apparatus and hardware devices are known that utilise overlap software or firmware to produce composite images with overlap, capable of being displayed on single channel or multi-channel display apparatus. The composite images can be displayed on single channel or multi-channel cathode ray tube monitor displays, liquid crystal device monitor displays, plasma displays or projected displays. The projected displays may be front or rear projected displays.

There are many ways of displaying composite images, and each means of display needs the images to be in the correct geometric configuration for the chosen display means. In many instances, for example when images are projected onto a cylindrical screen, the composite image needs to be distorted before being projected in order to ensure that the image appears geometrically correct to the observer. However, when images from different image sources, for example a flat plane image source and a computer generated out-of-the-window image source, are combined to make a composite image, then the application of distortion to the composite image will provide correction to the image from one image source but will in fact introduce distortion into the image from the second image source. Part or parts of the display will be geometrically correct to the observer, but the remainder of the display will appear incorrect as some distortion will have been introduced. This is particularly noticeable in multi-channel display systems where the images extend across joins or blend regions of the display.

It is an aim of the present invention to obviate or reduce the above mentioned problems.

Accordingly, in one non-limiting embodiment of the present invention there is provided image display apparatus for displaying composite images, which image display apparatus comprises a primary image source, at least one secondary image source, first distortion means for distorting the image geometry of the secondary image source such that the image geometry of the secondary image source matches that of the primary image source, combining means for combining images from the primary image source with the distorted images from the secondary image source, second distortion means for distorting the composite images, and display means for displaying the composite images.

The image display apparatus of the invention is able to display composite images from various image sources such that all parts of the display appear geometrically correct to an observer. The image display apparatus may be used in multi-media presentations, virtual reality displays, simulation, video or computer gaming, planetaria, and various other suitable and appropriate types of display means.

The display means may be a single-channel display means. Alternatively, the display means may be a multi-channel display means. The multi-channel display means may be a multi-channel display means with adjacent channels having edges that are butted. Alternatively the multi-channel display means may be a multi-channel display means in which adjacent channels are blended.

The display means may have a flat display surface, a curved display surface, a cylindrical display surface, or a spherical display surface. Alternatively, the display means may be of a complex geometric shape.

The primary image source will normally have images in a specific geometric configuration. This configuration varies with the type of image source. The primary image source is preferably a computer generated image source. The primary image source may be a computer image generator providing images with an out-of-the-window geometric configuration, as used in games or simulation. The primary image source may alternatively be a computer providing images with a flat plane geometric configuration such as a desktop personal computer. The primary image source may alternatively be photographic still or moving images having a specific geometric configuration due to lens distortion or specialist lenses such for example as a fisheye lens. The primary image source may be of any other suitable and appropriate type.

The secondary image source may be any one of the above mentioned sources for the primary image source. Typically the secondary image source has a different geometrical configuration to the primary image source. Both the primary image source and the secondary image source may be, for example, computer image generators, but both image sources would normally have different geometric configurations, or alternatively the primary and secondary image sources may be different types of image source.

The primary image source may have a geometric configuration which is specified by the manufacturer or which may be determined by calculation. The secondary image source may also have a geometric configuration which is specified by the manufacturer, or which may be determined by calculation. Having determined the geometry of the primary and secondary image sources, the distortion means is then applied to the images from the secondary image source so that the geometric configuration of the distorted secondary image source now matches the geometric configuration of the images from the primary image source. The distortion may be carried out, for example, electronically using image warping software or hardware. Other image warping techniques may be used.

The image display apparatus of the present invention may be one in which there are at least two of the secondary image sources, and in which each secondary image source undergoes the same degree of distortion prior to being combined with the primary image from the primary image source. Alternatively, the apparatus may be one in which there are at least two of the secondary image sources, and in which each secondary image source undergoes different distortion prior to being combined with the primary image from the primary image source.

As indicated above, images from the primary image source and the distorted images from the secondary image source are combined in the combining means. The combining means may be computer apparatus or hardware utilising overlap software or firmware in order to produce composite images with overlap capable of being displayed on single channel or multi-channel display apparatus.

The geometric configuration of the composite image is thus determined. All images in the composite image have matched geometries. The geometric configuration of the composite image matches that of the primary image source whose geometric configuration has previously been determined. Distortion correction is applied to the composite image. The distortion may be carried out, for example, electronically using image warping software or hardware. The distortion applied to the composite image may be calculated or determined such that when the composite image is displayed on the display means, then all parts of the composite image appear geometrically correct to the observer. Distortion applied to the composite image will normally be dependent on the display means.

The display means for displaying the composite images may be single-channel or multi-channel display means such for example as cathode ray tube displays, liquid crystal device flat panels, plasma, or front or rear projected displays. The combining means may incorporate known means for edge matching adjacent channels in a multi-channel display, or merging the display across blend regions in a multi-channel display.

Applying distortion correction to the secondary image source such that it matches that of the primary image source before combining the images, enables the composite image to be matched to the display means. It also enables the composite image to be displayed such that the composite image is geometrically correct to the observer. If the primary image and the secondary image are combined in the combining means, the respective geometries not having been matched, when the combined image is distorted and displayed, the geometries will not match and therefore part or parts of the composite image will not appear geometrically correct to the observer.

As indicated above, the apparatus of the present invention may be used with more than one secondary image source. Each of the secondary image sources may in turn be distorted to match the geometric configuration of the primary image source. Combining means may be used to combine the primary image source with the distorted secondary image sources, distortion then being applied to the composite image such that the displayed composite image appears geometrically correct to the observer. All the composite parts, that is images from the primary image source and each of the secondary image sources, of the combined image therefore appear correct to the observer.

Embodiments of the invention will now be described solely by way of example and with reference to the accompanying drawings in which:

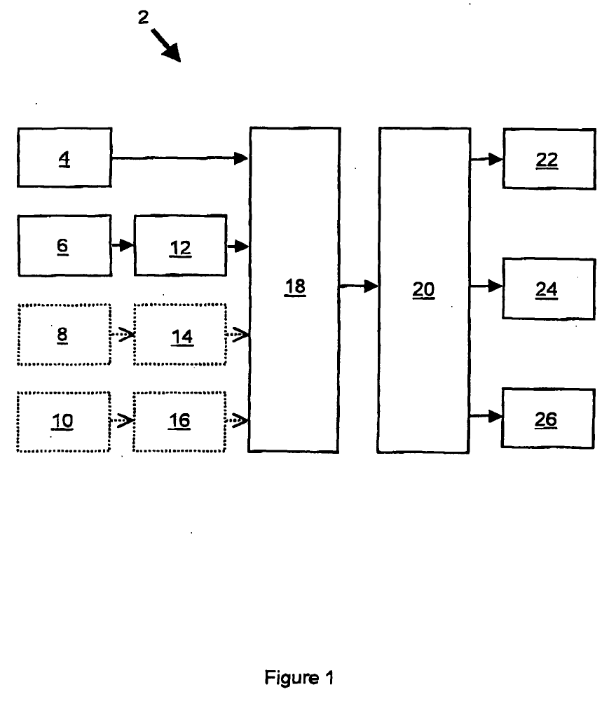

FIG. 1 shows schematically image display apparatus of the present invention for displaying composite images;

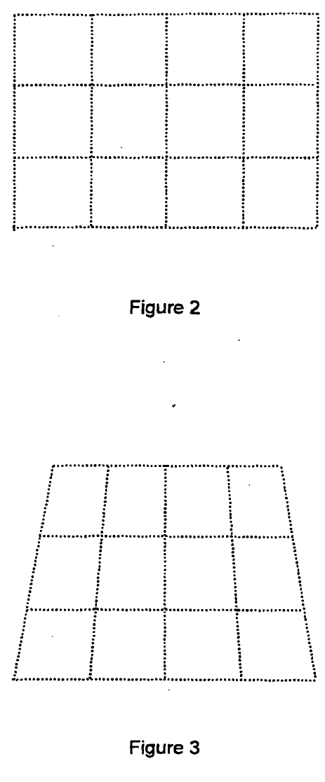

FIG. 2 shows the geometry of a flat image;

FIG. 3 shows the geometry of an image with keystone distortion;

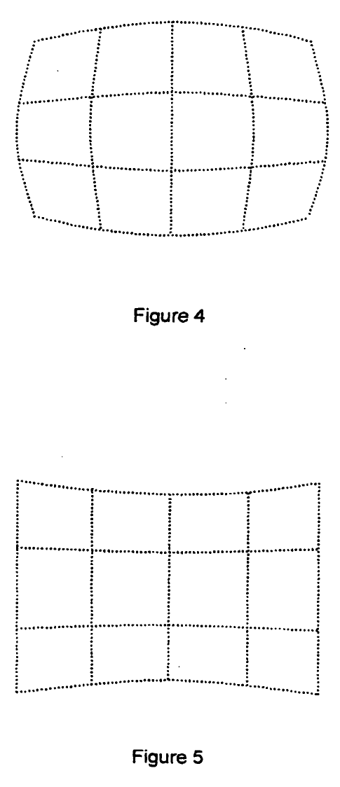

FIG. 4 shows the geometry of an image with barrel distortion;

FIG. 5 shows the geometry of an image with pin cushion distortion;

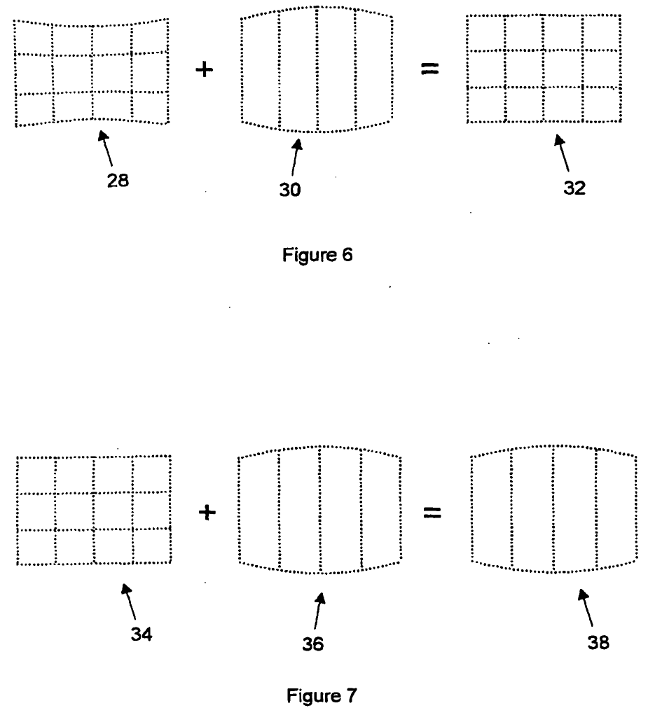

FIG. 6 shows figuratively distortion correction to a pin cushion image;

FIG. 7 shows figuratively distortion applied to a flat Image;

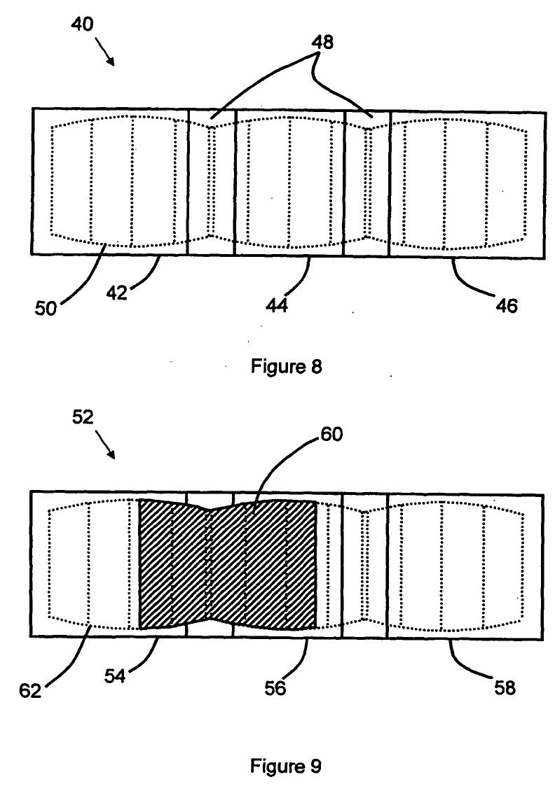

FIG. 8 shows a known three-channel display with blended images;

FIG. 9 shows a known three-channel display with a blended combined image;

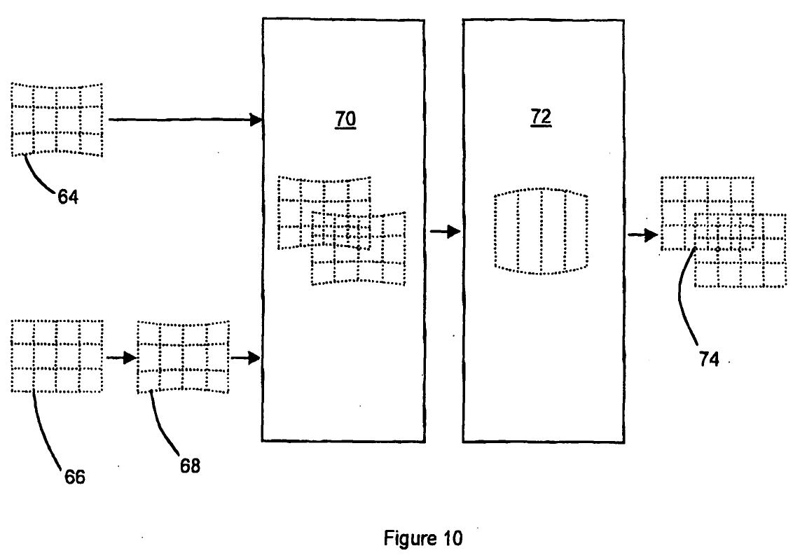

FIG. 10 shows distortion schematically in the present invention;

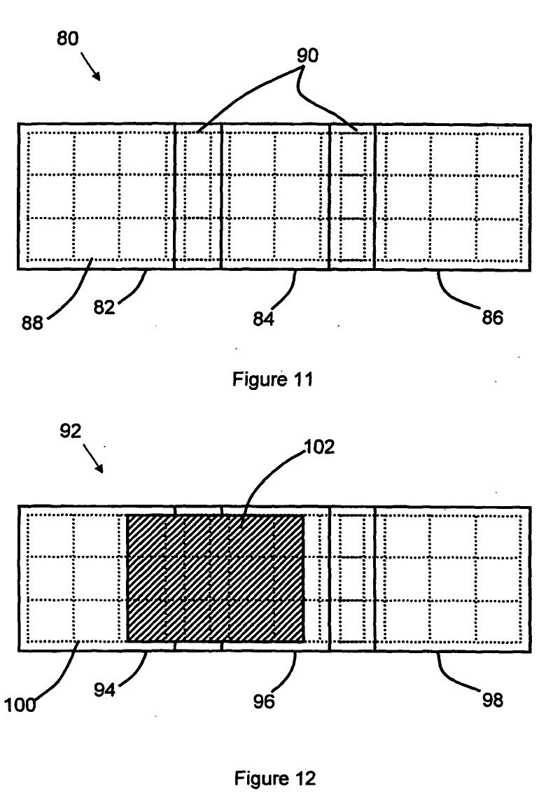

FIG. 11 shows a three-channel display with blended images; and

FIG. 12 shows a three-channel display with a blended combined image of the invention.

Referring to the drawings, FIG. 1 shows schematically an embodiment of image display apparatus 2 of the present invention and for displaying composite images. A primary image source 4 inputs directly into image combining means 18. A secondary image source 6 inputs into first image distortion means 12. The first image distortion means 12 inputs into the image combining means 18.

The first image distortion means 12 applies distortion to images from the secondary image source 6 such that the geometric configuration of the images matches that of the primary image source.

One or more secondary image sources may be used. FIG. 1 shows an additional secondary image source 8 that undergoes distortion by first distortion means 14. FIG. 1 also shows a further additional secondary image source 10 that undergoes distortion by first distortion means 16. The geometrical configuration of all the image sources is common at the stage where they are input into the image combining means 18.

The composite image from the image combining means 18 is output to second distortion means 20. The second distortion means 20 operates such that the composite image is distorted such that when the composite image is displayed on display means 22, then the image appears geometrically correct to the observer. The composite output image may be output on one channel in the form of the display means 22. Alternatively, the composite image may be output to display means 22, 24, 26 for a three-channel display. The display means may be a single channel or a multi-channel display.

FIG. 2 shows the two dimensional geometry of an image formed in a flat image space.

FIG. 3 shows the two dimensional geometry of an image formed in a flat image space with a keystone distortion.

FIG. 4 shows the two dimensional geometry of an image that has a barrel distortion. Barrel distortion may be introduced into images such as videos due to the effects of lenses that are used.

FIG. 5 shows the two dimensional geometry of a computer generated image of the world. This is representative of the three-dimensional world and images of this type need to undergo distortion before being displayed by projection on a flat screen.

FIG. 6 shows the distortion that is applied to the geometric image configuration shown in FIG. 5. This distortion is applied such that the image appears correct to an observer when viewed on a screen. The original image 28 is distorted via a function represented by 30. The resultant image geometry is indicated by 32. If a complementary distortion 30 is used, then the resultant image will appear correct to the observer. The distortion applied by distortion means 30 will vary with respect to the initial distortion of the image and with the final display means chosen.

FIG. 7 shows that an image 34 with a regular geometric configuration can have a distortion 36 applied to it, in order to produce a final image 38 that is distorted. This final image 38 will not appear to be correct to the observer and it will appear to be warped.

FIG. 8 shows known three-channel display means 40 with blend regions 48 and channels indicated by 42, 44 and 46. The geometric configuration 50 of the left channel is shown. This configuration has been produced in accordance with the distortion procedure mentioned above in connection with FIG. 7. The image in each channel has some distortion. The distortion in each channel need not necessarily be the same.

FIG. 9 shows known three-channel display means 52 with channels indicated by 54, 56 and 58 for displaying composite images. The geometric configuration 62 of the left channel is shown. This configuration has been produced in accordance with the above mentioned distortion procedure described for FIG. 7. Part of the composite image 60 is shown. The distortion introduced is particularly noticeable across the blend region. In composite images, this part of the image 60 may be, for example, a desk top personal computer, and would appear distorted to the observer. The background or surrounding images may appear correct since the distortion applied to the composite image would correct this part of the composite image.

FIG. 10 shows image display apparatus of the present invention for displaying combined images. The image display apparatus has a primary image source 64, with images in an associated geometrical configuration as shown. The image display apparatus has a secondary image source 66, with images in an associated geometrical configuration as shown. The image display apparatus has distortion means 68 for distorting the images from the secondary image source. The image display apparatus also has combining means 70 for combining the images from the primary image source with the distorted images from the secondary image source. Distortion means 72 is employed for distorting the composite images. Display means 74 is employed for displaying the composite image. It can be seen that the images have the same geometric configuration when input into the combing means 70. Consequently, any distortion applied to the composite image has the same effect on all parts of the composite image, and the composite image is displayed with all parts appearing to be correct to the observer.

FIG. 11 shows three-channel display means 80 for use in the image display apparatus of the present invention. The three-channel display means 80 has blend regions 90, and channels indicated by 82, 84 and 86. The geometric configuration 88 of the left channel is shown. This geometric configuration has been produced in accordance with the distortion procedure described above with reference to FIG. 10.

FIG. 12 shows three-channel display means 92 for use in display apparatus of the present invention. The three channels are indicated by 94, 96 and 98. The geometric configuration of the left hand channel is indicated by 100. Part of the composite image is indicated by 102. This part of the composite image has no distortion, and it appears geometrically correct to the observer, especially across the blend region.

It is to be appreciated that the embodiments of the invention described above with reference to the accompanying drawings have been given by way of example only and that modifications may be effected.

1. Image display apparatus for displaying composite images, which image display apparatus comprises a primary image source, at least one secondary image source, first distortion means for distorting the image geometry of the secondary image source such that the image geometry of the secondary image source matches that of the primary image source, combining means for combining images from the primary image source with the distorted images from the secondary image source, second distortion means for distorting the composite images, and display means for displaying the composite images.

2. Image display apparatus according to claim 1 in which the display means is a single-channel display means.

3. Image display apparatus according to claim 1 in which the display means is a multi-channel display means.

4. Image display apparatus according to claim 3 in which the multi-channel display means is a multi-channel display means with adjacent channels having edges that are butted.

5. Image display apparatus according to claim 3 in which the multi-channel display means is a multi-channel display means in which adjacent channels are blended.

6. Image display apparatus according to claim 1 in which the display means has a flat display surface.

7. Image display apparatus according to claim 1 in which the display means has a curved display surface.

8. Image display apparatus according to claim 1 in which the display means has a cylindrical display surface.

9. Image display apparatus according to claim 1 in which the display means has a spherical display surface.

10. Image display apparatus according to claim 1 in which the primary image source is a computer generated image source.

11. Image display apparatus according to claim 1 in which secondary image source is of a different geographical configuration to the primary image source.

12. Image display apparatus according to claim 1 in which the secondary image source is a computer generated image source.

13. Image display apparatus according to claim 1 in which there are at least two of the secondary image sources, and in which each secondary image source undergoes the same degree of distortion prior to be combined with the primary image from the primary image source.

14. Image display apparatus according to claim 1 in which there are at least two of the secondary image sources, and in which each secondary image source undergoes different distortion prior to be combined with the primary image from the primary image source.

15. (canceled)
